(19) United States
(12) Patent Application Publication
(10) Pub. No.: US 2013/0126575 A1
(43) Pub. Date: May 23, 2013

(54) BLADE FOR CUTTING A PIECE OF PLASTERBOARD, METHOD FOR IMPLEMENTING SAID BLADE, AND USE THEREOF

(71) Applicant: Benoit Mallet, Evereux (FR)

(72) Inventor: Benoit Mallet, Evereux (FR)

(21) Appl. No.: 13/642,381

(22) PCT Filed: Apr. 18, 2011
(86) PCT No.: PCT/IB11/51676

§ 371 Date: Feb. 6, 2013

(30) Foreign Application Priority Data
Apr. 21, 2010 (FR) 1001703

(51) Int. Cl. B26F 3/00; B26D 3/08; B26D 7/00

(52) U.S. Cl. CPC B26F 3/002; B26D 7/00; B26D 3/08
USPC 225/2; 83/651; 83/880

(57) ABSTRACT

The invention relates to a solution for rapidly grooving a piece of plasterboard, enabling the creation of a plane cutting edge and a precise cut-out of the layer(s) of paper or cardboard. To this end, according to the invention, the cutting is carried out in three main steps by means of a blade having a particular shape and sharpness: a step of grooving, a step of breaking the plasterboard, and a step of levelling the cutting edge. The invention therefore relates to a blade (300) for cutting a piece of plasterboard, characterised in that it comprises at least one grooving corner (301) having a plane face and a bevelled face.

The invention relates to a blade for cutting a panel of plasterboard, to a method for implementing same and to a use of the blade.

A panel of plasterboard is a panel made of a layer of plaster covered, on at least one face, by a panel of cardboard or of paper. Generally, the two faces of the panel are covered by a sheet of cardboard or of paper.

The panels of plasterboard are generally produced in a factory, and are used to make partitions, ceilings, etc. These panels therefore replace the use of plaster powder diluted in water to coat walls, which is a tiring and lengthy operation and which requires significant know-how to obtain an optimal composition of the plaster and a satisfactory flatness of the coated surface.

These panels have the advantage of being easy to handle and of allowing for rapid work. Furthermore, the know-how needed to position them is less than with traditional plaster. Finally, the factory production makes it possible to obtain plasters of optimal composition. However, for cost and management reasons, factory production entails producing panels of standard sizes.

Although there are different standard dimensions, in length, in width and in thickness, it is often necessary to cut these panels to adapt them to the widths and lengths of the walls or of the ceiling of the room in which they are to be used.

This cutting, done on a worksite at the ideal dimensions, must be rapid and as clean as possible to allow two panels to be easily positioned contiguously.

Finally, a finishing has to be done by filling the interstice between two contiguous panels of plaster, using a filler product such as plaster or ready-to-use coating. Once deposited, this filler product is smoothed with the coating knife.

The finishing step must be as rapid as possible. For this, the number of gestures to be made by the user must be limited. A clean cutting of the panels would make it possible not only to limit the quantity of filler product used, but also the number of gestures to be made to smooth the surface on and in the vicinity of the interstice.

There are a number of solutions for cutting a panel of plasterboard.

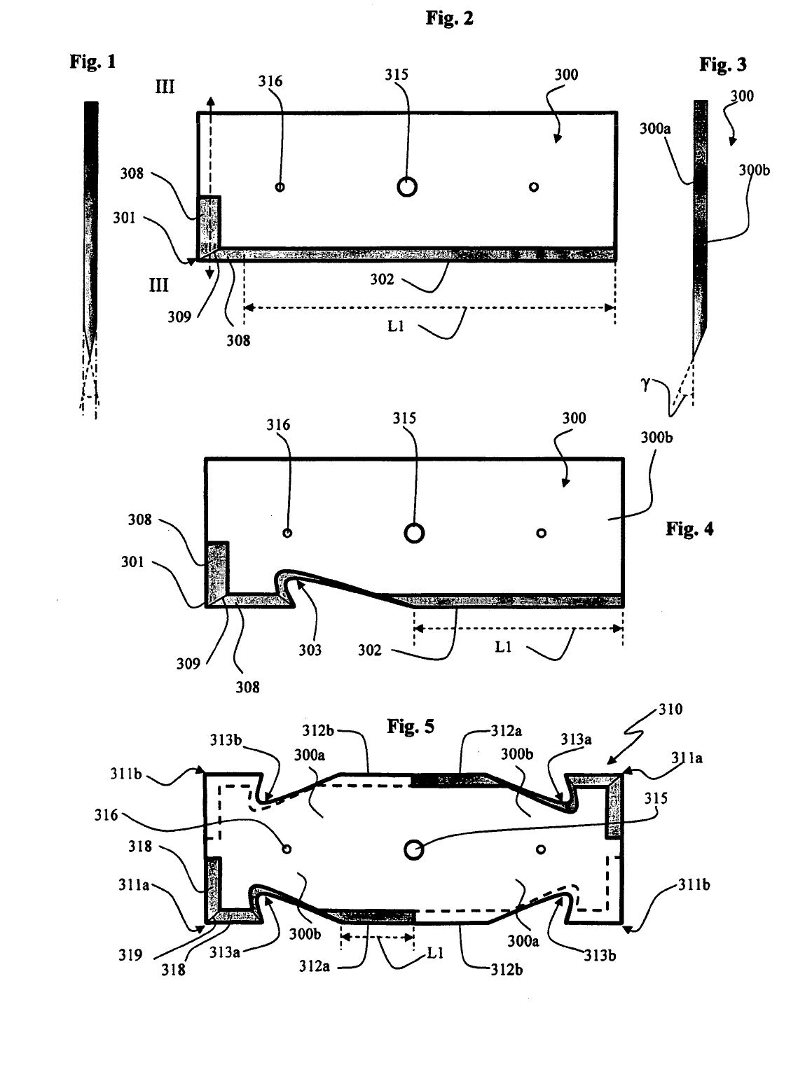

The most widely used consists in “marking” the panel with a cutter blade (a cutter blade, known from the prior art and illustrated in FIG. 1, consists of a plate having a doubly beveled edge, that is to say that the two faces of the plate are beveled).

This operation makes it possible to cut the first sheet of cardboard and score the layer of plaster. Then, the operator exerts a strain on the panel so that the layer of plaster is broken into two parts along the score. Finally, the operator cuts the second sheet of cardboard with his cutter to free the two parts of the panel. Generally, during this last step, the second sheet of paper is torn away rather than cut, which creates an unevenness on the surface of the panel of plasterboard that has to be filled during the finishing step.

This solution is dangerous to the operator because of the use of the cutter. In practice, the scoring obtained is never rectilinear, even with the use of a guide, and it often happens that the speed of the scoring movement results in a sudden drift of the blade of the cutter from the guide to the body of the user.

This solution also has a big technical drawback. First of all, the use of a blade of the cutter generates non-rectilinear scores so that the break can take forms that are so irregular that a new panel has to be used and cut. Then, the cutting edge, obtained after having broken the layer of plaster, is always very uneven, even with long experience. It is then difficult to fit two consecutive panels for which the cutting edge is uneven. It is also necessary, during the finishing steps to use a significant quantity of filler material to obtain a perfectly planar surface between the two consecutive panels.

It is for this reason that some companies prohibit their workers from using this practice. Some public institutions even prohibit this practice in their calls for bids, but in practice, it is the method most widely used.

To overcome this problem, some operators have proposed a second cutting solution consisting in using a straight-back hand saw or a pad saw. The tooth size for the blade of this saw has to be chosen with care to avoid plaster chips and generating an uneven cutting edge. For the same reason, the cutting speed and frequency must also be suitable, which requires significant know-how.

When well done, this second cutting solution makes it possible to obtain a clean cutting edge. Nevertheless, this solution takes longer than manual cutting using the cutter. Furthermore, the panels of plasterboard of small thickness (less than or equal to 18 mm) are unsuited to the use of a saw. This solution becomes advantageously only for thicknesses greater than 18 mm because, beyond this thickness, the strain to be exerted to break the layer of plaster is too great and the break does not necessarily follow the score.

The objective of the present invention is therefore to propose a solution for rapidly and cleanly scoring a plate of plasterboard.

Another objective is to propose a complete solution for cutting a plate of plasterboard, making it possible to both obtain a planar cutting edge, that is to say without plaster protuberance, and a clean cut of the panel(s) of paper or of cardboard.

For this, the invention proposes performing the cut in three main steps, using a blade having a particular form and sharpness: a scoring step, a step of breaking the plate of plaster, and a step of trimming the cutting edge.

To this end, the subject of the invention is a blade for cutting a panel of plasterboard, comprising at least one scoring corner having a planar face and a beveled face.

The beveled face makes it possible to cut the first sheet of cardboard and score the layer of plaster, and the planar face makes it possible to hold the blade in the same position during the scoring of the plaster. The inventor has observed that it is this holding of the position of the blade which makes it possible to obtain a cutting edge that is much more even than when using cutter blades. Since the latter are beveled on each face, it is impossible, even with a guide, to hold the blade in position, so that these blades deviate and the cutting edge that is consequently obtained is irregular.

According to other embodiments:
the scoring corner may be extended by a trimming edge having a planar face and a beveled face that are identical to those of the corner.
the cutting blade may also comprise at least one cutting notch arranged between the scoring corner and the trimming edge.
the beveled face may form an angle with the planar face of between 15° and 25°, preferably 20°.
the or each scoring corner may have a connecting facet;
the trimming edge may have a length greater than the thickness of the panel of plasterboard;
the cutting notch may be curved;
the cutting blade may consist of a rectangular plate having two faces and comprising:
   four scoring corners;
   four cutting notches;
   four trimming edges,
two diametrically opposite scoring corners being symmetrical relative to the center of the rectangular plate, two consecutive scoring corners having a planar face and a beveled face that are opposite one another; and/or
the cutting blade may consist of a rectangular plate having two faces and comprising:
   four scoring corners;
   four cutting notches;
   four trimming edges,
two diametrically opposite scoring corners being symmetrical relative to the center of the rectangular plate and two consecutive scoring corners having one and the same planar face and one and the same beveled face.

The invention also relates to a method for implementing a blade according to the invention, for cutting a panel of plasterboard, the method comprising the following steps:
supplying a panel of plasterboard comprising a layer of plaster between two sheets of cardboard or of paper;
applying the scoring corner to the panel so that the planar face of the scoring corner is at right angles to the panel, and displacing the duly positioned blade to cut the first sheet and score the layer of plaster;

According to other embodiments, the method may comprise the following subsequent steps:
folding the panel along the score obtained in the preceding step to break the layer of plaster along the score and obtain a cutting edge;
engaging the cutting notch with the second sheet of cardboard and applying the trimming edge against the cutting edge obtained in the preceding step, then displacing the duly positioned blade to trim the cutting edge while cutting the second sheet of cardboard.

The invention also relates to the use of a blade according to the invention, comprising at least one scoring corner, at least one cutting notch and at least one trimming edge, for cutting a panel of plasterboard.

Other features and advantages of the invention will emerge from the following detailed description, given with reference to the appended figures which represent, respectively:

FIG. 1, a cross-sectional schematic view of a cutter blade illustrating the state of the art;

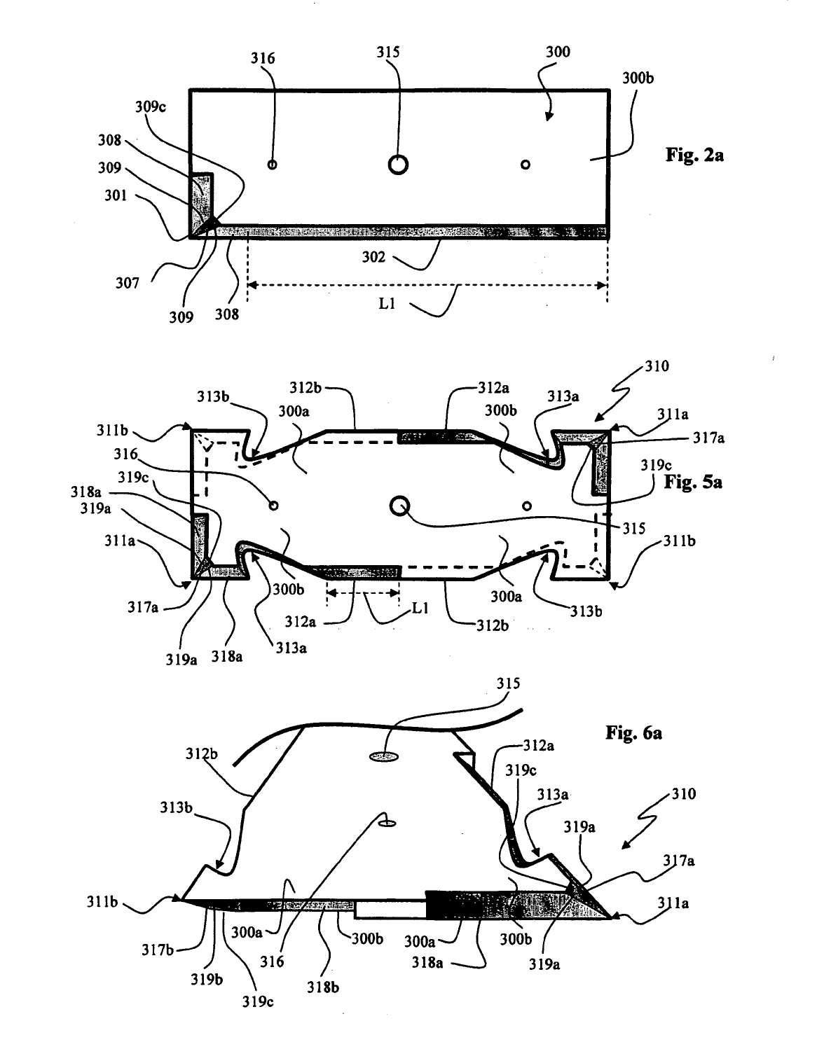

FIG. 2, a plan schematic view of a first embodiment of a blade according to the invention;

FIG. 3, a cross-sectional schematic view along the line III-Ill of the blade of FIG. 2;

FIGS. 4 and 5, plan schematic views of two embodiments of a blade according to the invention;

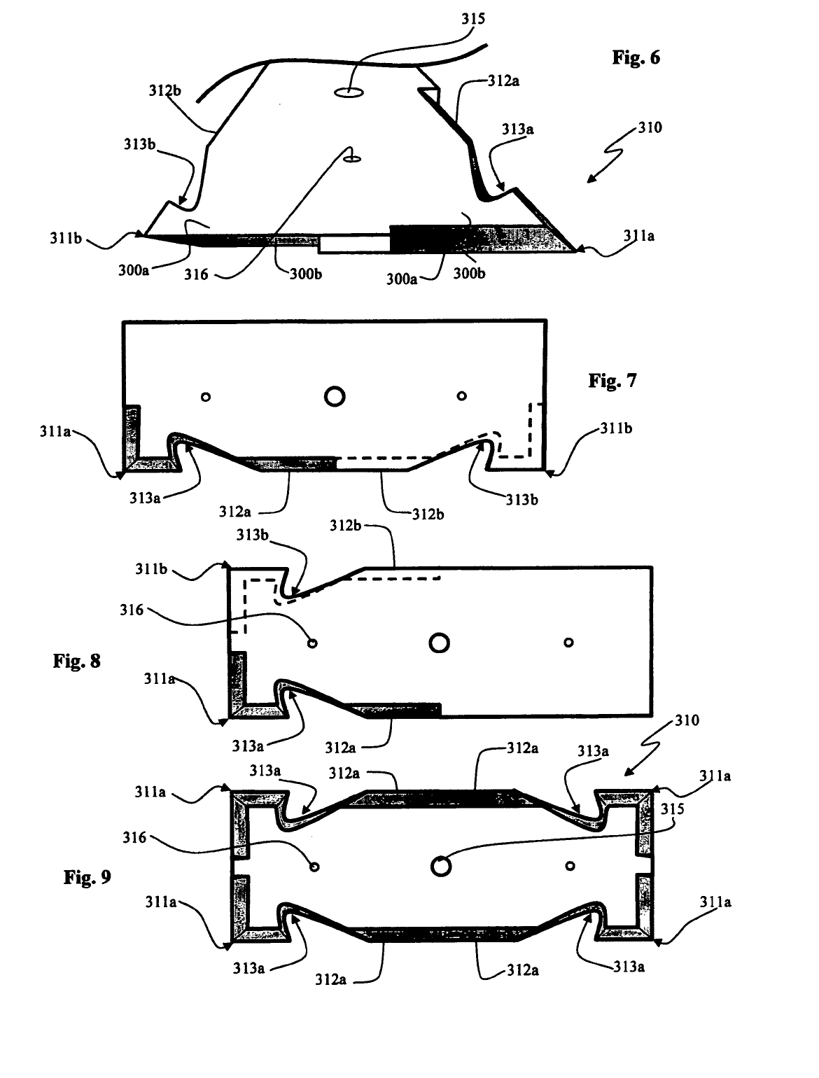

FIG. 6, a partial perspective schematic view of the blade of FIG. 5;

FIGS. 7 to 9, plan schematic views of three other embodiments of a blade according to the invention;

FIGS. 2a, 5a and 6a, schematic views of variants, respectively, of the blades of FIGS. 2, 5 and 6;

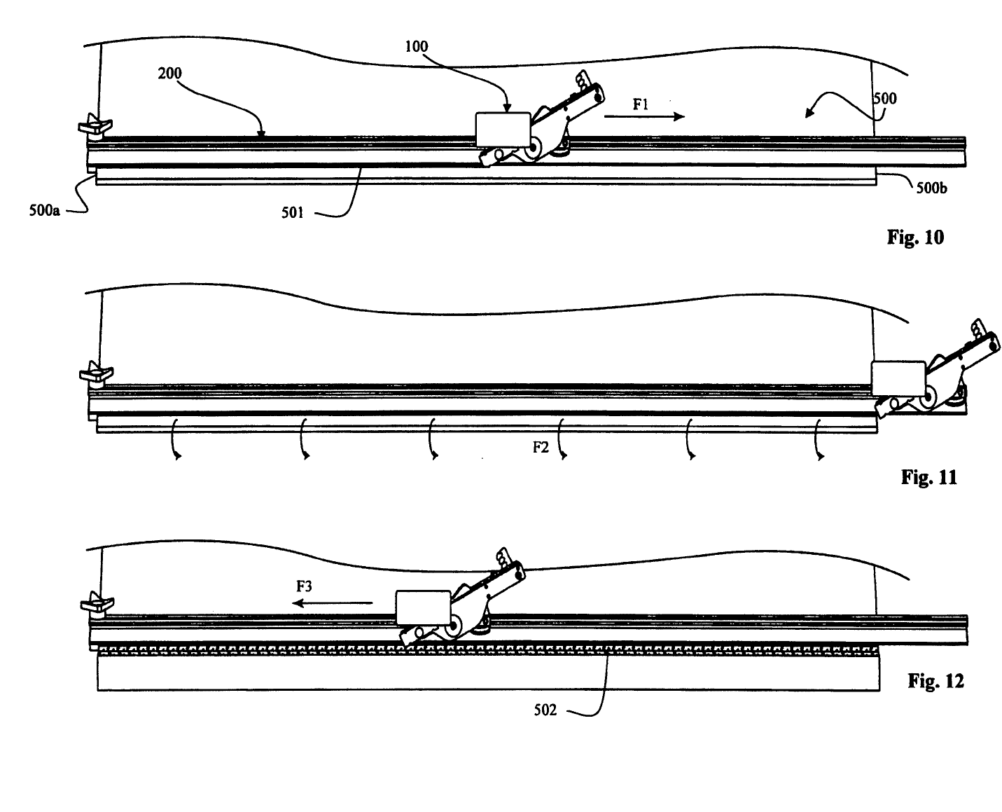

FIGS. 10 to 13, perspective schematic views of an implementation of the cutting method according to the invention;

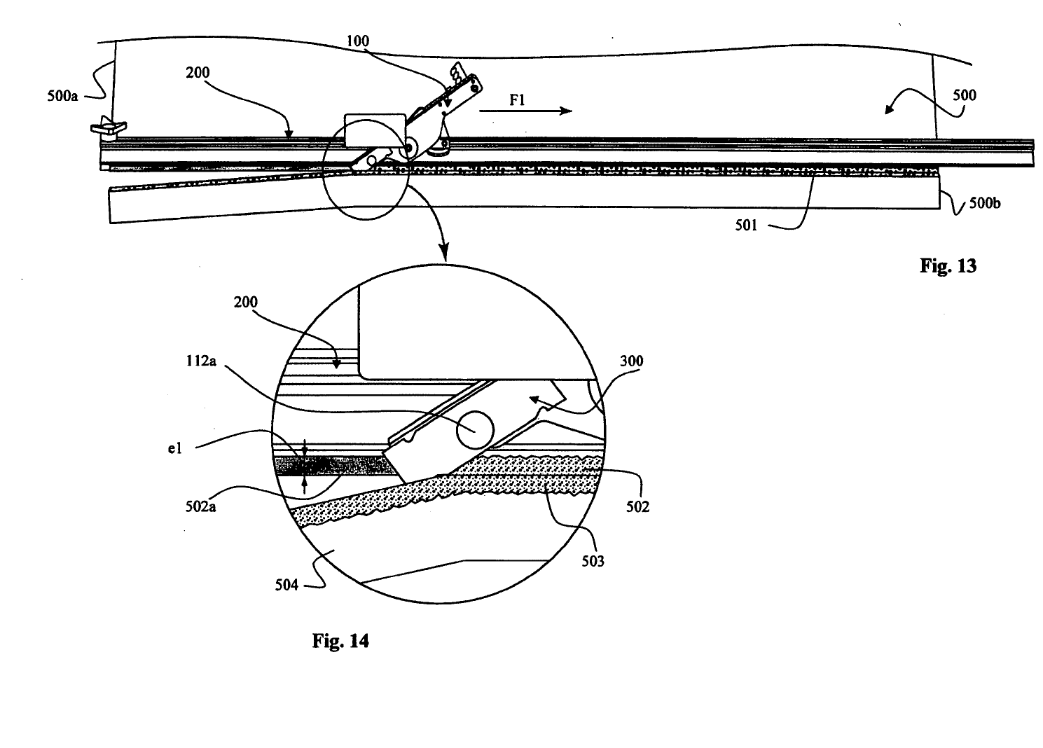

FIG. 14, a perspective partial embodiment of FIG. 13 illustrating the surface condition obtained after trimming of the edge of the panel of plasterboard;

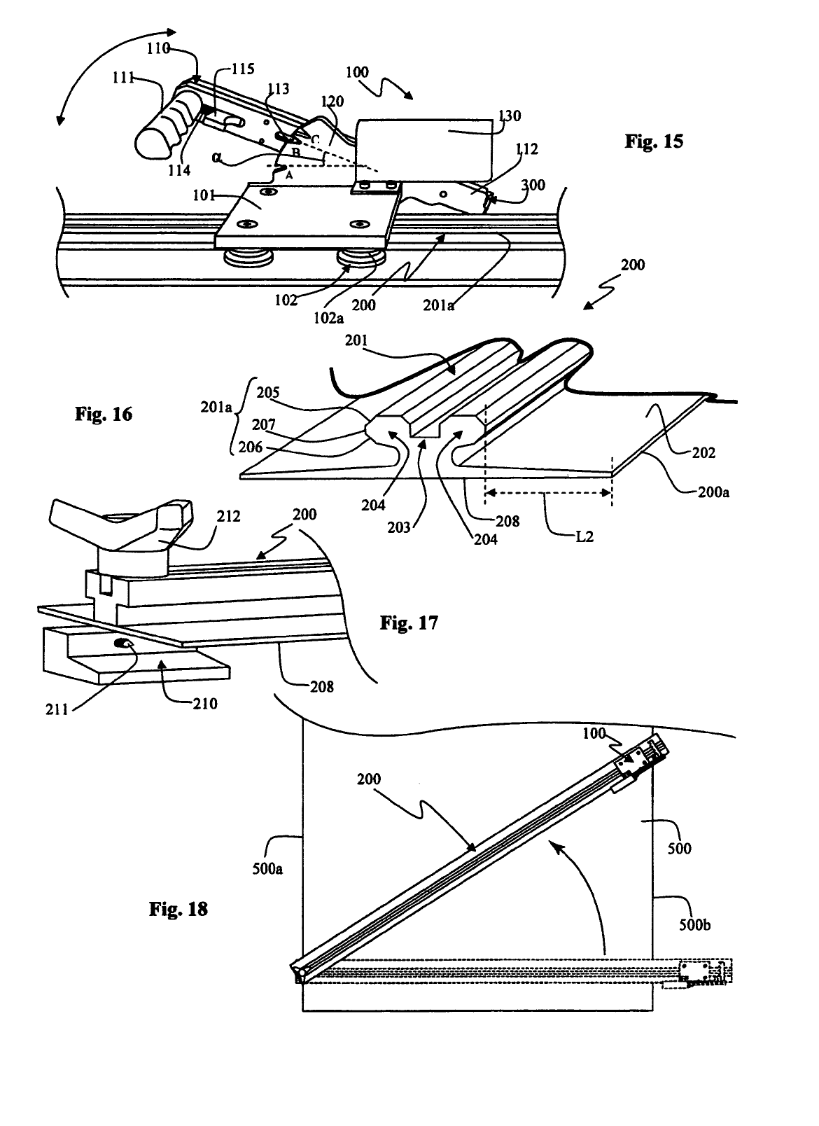

FIG. 15, a left side perspective schematic view of an exemplary carriage supporting a blade according to the invention;

FIG. 16, a perspective partial schematic view seen from above, relative to the position of use, of a cutting guide that can be used with a blade according to the invention;

FIG. 17, a partial perspective schematic view of one end of a cutting guide that can be used with a blade according to the invention; and

FIG. 18, a plan schematic view of a step of positioning a cutting guide according to the invention.

Unlike the cutter blade illustrated in FIG. 1 and comprising a doubly beveled cutting edge, a cutting blade 300 according to the invention, illustrated in FIG. 2, comprises at least one scoring corner 301 presenting, in cross section, a planar face 300a and a beveled face 300b (see FIG. 3). The corner is therefore defined by, on one side, a planar face, and on the other side, by a beveled face having two beveled edges 308. The two beveled edges 308 are linked by at least one coupling line 309.

This particular form of the cutting edge of the blade ensures a perfectly rectilinear scoring while preventing the blade from oscillating during the scoring, unlike what is observed with a cutter blade.

The beveled face makes it possible to cut the first sheet of cardboard and score the layer of plaster, and the planar face makes it possible to hold the blade in the same position during the scoring of the plaster. The inventor has observed that it is this holding of the position of the blade at right angles to the panel of plasterboard that makes it possible to obtain a perfectly rectilinear scoring and a cutting edge that is much more even than when using cutter blades. Since the latter are beveled on each face, it is very difficult, even impossible, even with a guide, to hold the blade in position, so that these cutter blades drift and the cutting edge that is consequently obtained is very irregular.

The best results have been obtained with an angle γ between the planar face and the beveled face of between 15 and 25°, and preferably an angle γ of 20°. Thus, when the bevel has such an angle, the blade remains perfectly rectilinear and does not oscillate during the scoring. Furthermore, the scoring obtained has a depth and a form such that, when the user folds the panel of plasterboard (see FIG. 11), the edge obtained is much more even than that obtained with a cutter blade.

In order to further enhance the evenness and the flatness of the cutting blade, the blade also comprises a trimming edge 302 which also has a planar face and a beveled face. The trimming edge 302 has a length L1 greater than or equal to the thickness of the panel of plasterboard. If this thickness is denoted e, the length L1 of the trimming edge must be greater than or equal to: e/sine β, β being the angle between the blade and the panel of plasterboard during the trimming step.

Advantageously, the scoring step and the trimming step is performed with a cutting carriage bearing the blade according to the invention, and mounted to slide on a cutting guide. A carriage that is particularly suited to the use of the blade and a guide will be described with reference to FIGS. 15 to 18.

In a particularly advantageous embodiment, the blade comprises, between the scoring corner 301 and the trimming edge 302, a cutting notch 303. This notch is useful when the panel of plasterboard comprises a sheet of paper or of cardboard on the bottom face of the panel of plasterboard, in the cutting position. Thus, during the step of trimming the cutting edge, this sheet of paper or of cardboard is engaged in the notch 303 which allows for a clean and even cut of this sheet and prevents this sheet from being simply torn. Advantageously, to facilitate this cutting, the cutting notch is curved.

The concomitance of the trimming of the cutting edge and of the cutting of the bottom sheet of paper makes it possible to obtain a cut panel of plasterboard of which none of the sheets of paper is torn and whose cutting edge has no protuberance and perfectly follows the scoring line. When a guide is used, the cutting edge is parallel to the guide (therefore perfectly rectilinear if the guide is a straight rule). The juxtaposition of a number of panels of plasterboard cut using the blade according to the invention is therefore optimized, and the quantity of filler materials for the finishing steps is greatly limited. Furthermore, the fact that the sheets of paper or of cardboard are not torn, prevents having to fill the surface irregularities of the panel of plasterboard.

Usually, on a work site, it is necessary to perform numerous cuts of panels of plasterboard. All these cuts wear the blade, so that the latter can be blunted during the cutting movements (see FIGS. 10 to 14). The scoring is therefore no longer rectilinear and, when the user folds the panel of cardboard (see FIG. 8), the cutting edge may no longer be perfectly parallel to the scoring line and/or to the guide, and may exhibit great unevenness (presence of numerous protruding protuberances). It is therefore necessary to change the blade.

A particularly advantageous embodiment of a blade is illustrated in FIGS. 5 and 6. In this embodiment, the four corners of the plate forming the blade are used as scoring corners. Each of these corners is extended by a trimming edge. Between each corner and the trimming edge, the blade bears a cutting notch. In this embodiment, two diametrically opposite scoring corners 311a-311a are symmetrical relative to the center of the rectangular plate forming the blade 310. On the other hand, two consecutive scoring corners 311a-311b have a planar face and a beveled face opposite. This means, as illustrated in FIG. 6, that a scoring corner 311a has a beveled top face and a planar bottom face. On the other hand, a scoring corner 311b has a planar top face and a beveled bottom face. The same applies to the other structures that are the trimming edges 312a and 312b and the cutting notches 313a and 313b.

According to the invention, the blade has a hole 315 intended to cooperate with a bolt provided with a nut 112a (see FIG. 14) positioned in the recess 112 for receiving the blade of the carriage 100. The blade 310 also comprises holes 316 intended to cooperate with fixed rods arranged in the recess 112 to secure the blade and prevent it from pivoting about the bolt 112a. Obviously, any other means of fixing the blade in the recess can be used, provided that this fixing means firmly secures the blade at right angles to the panel of plasterboard.

In this way, with a blade according to the invention, the planar face 300a of the blade 300 is held at right angles to the panel of plasterboard during the scoring and the trimming.

The embodiment of FIG. 5 makes it possible to use the two scoring corners 311a by pivoting the blade and to use the two scoring corners 311b by turning over the blade. Thus, with one and the same blade 310, four scoring and trimming areas are obtained that can be used in succession when one of these areas is worn.

Obviously, as FIGS. 7 and 8 show, the blade may bear only two areas each comprising a scoring corner, a trimming edge and a cutting notch.

FIG. 9 illustrates another embodiment of a blade according to the invention, suitable for both left-handed users and right-handed users. This blade 320 has four scoring corners 321, four trimming edges 322 and four cutting notches 323. In this embodiment, two diametrically opposite scoring corners are symmetrical relative to the center of the rectangular plate and two consecutive scoring corners have one and the same planar face and one and the same beveled face. With this embodiment, it is possible to produce a blade that can be used either from left to right or from right to left.

To this end, provision can be made for the cutting carriage according to the invention to be dismantlable and to be configured either for a right-handed user or for a left-handed user. Thus, the section piece having the notches, and the handle can be fixed on both sides of the chassis. When there is a protective cap, provision is also made for this cap to be able to be dismantled and fixed either for a right-handed user or for a left-handed user. FIGS. 1 to 6 illustrate a suitable arrangement for use by a right-handed user.

In the embodiment of FIG. 9, the four corners are used to offer, to a right-handed user and to a left-handed user, two cutting areas that can be used in succession when the first to be used is worn. Obviously, it is possible to provide only one cutting area for a right-handed user and only one cutting area for a left-handed user.

The method of cutting with a blade according to the invention is described hereinbelow.

On a panel of plasterboard, the user draws the cut that he wants.

Then he places the blade according to the invention at a first edge of the panel.

The user positions the blade so that the scoring corner is in sufficient contact with the panel to score it, and that the planar face of the blade is at right angles to the panel.

The user then displaces the blade, while holding it at right angles to the panel, from the first edge of the panel 500 to a second edge of the panel. During this movement, the blade makes a score in the layer of plaster of the panel. If this layer of plaster is covered with a sheet of paper or of cardboard, the blade cuts this sheet at the same time as it is scoring the plaster.

Having arrived at the second edge of the panel, the user folds the panel along the score obtained in the preceding step to break the layer of plaster along the score. This folding makes it possible to obtain a cutting edge. By virtue of the form of the blade and the way it is held so that the planar face is at right angles to the panel during the displacement, the score obtained is regular and the cutting edge obtained is much more regular than the cutting edges obtained by the method of cutting using the cutter: the protuberances present on the edge are much smaller and more even than those which are obtained by the method of cutting using the cutter.

To further enhance the flatness of this cutting edge, the blade according to the invention advantageously comprises a trimming edge which makes it possible to trim the cutting edge.

For this, the user positions the blade at the first edge 500a of the panel 500, so that the planar face of the trimming edge is applied against the cutting edge obtained in the step of folding the panel, and at right angles to the faces of the panel. The user again displaces the blade positioned in this way, so that the cutting edge is trimmed by the blade at right angles to the faces of the panel.

At the same time as the blade trims the cutting edge, it also cuts, if present, the sheet of paper or of cardboard arranged on the bottom face of the panel of plasterboard. To this end, a blade is advantageously used which comprises a cutting notch (see FIGS. 4 to 9).

Thus, during the positioning, the user engages the cutting notch with the second sheet of cardboard and applies the trimming edge against the cutting edge obtained in the preceding step, then displaces the duly positioned blade to trim the cutting edge while cutting the second sheet of cardboard.

FIGS. 2a, 5a and 6a illustrate variants, respectively, of the blades of FIGS. 2, 5 and 6.

In these variants, the or each scoring corner 301-311a-311b has a connecting facet 307-317a-317b between the two beveled edges 308-318a-318b of the scoring corner.

The connecting facet 307-317a-317b is delimited by two coupling lines 309-319a-319b, as well as by a coupling line 309c-319c with the face 300b. The connecting facet 307-317a-317b forms a plane making an angle δ with the planar face 300a. The angle δ is less than the angle γ of the beveled edges 308 with the planar face 300a. Advantageously, the angle δ is between 10 and 20, and preferably an angle δ of 15°. The preferred embodiment is an angle γ of 20° and an angle δ of 15°.

The connecting face 307-317a-317b facilitates the penetration of the blade into the panel of plaster during the scoring and limits the forces during the operation. Furthermore, the inventor has observed that the force that is exerted on the scrap piece to break the panel of plaster is also limited.

In practice, the connecting face 307-317a-317b very substantially improves the score obtained during the scoring step (see FIG. 10). When the connecting face is absent, the single coupling line 309 may rub strongly against the plaster and tear away small pieces of plaster and of paper or of cardboard during the scoring. The score may therefore sometimes exhibit, in particular when the scoring is very rapid, scratches which result, when the panel is folded (see FIG. 11), in a cutting edge that is not very regular. The connecting face 307-317a-317b limits the friction between the scoring corner and the panel, so that the score obtained is particularly regular. It exhibits almost no scratching. The cutting edge obtained is very regular and exhibits only very few protrusions, and protrusions of small sizes. The subsequent trimming step is therefore facilitated and constitutes only a finishing to obtain a perfectly planar cutting edge, with no protrusion hindering the positioning of two panels one against the other.

FIGS. 10 to 14 illustrate the preceding cutting method, implemented with a carriage cooperating with a guide and bearing the blade according to the invention. This cutting system enables the blade to be secured very effectively so that the planar face of the blade remains perfectly at right angles to the faces of the panel of plasterboard during the scoring and the trimming.

On a panel of plasterboard 500, a cutting guide 200 is positioned along the cutting direction desired by the user. Before or after this position, the user makes the carriage 100 cooperate in a sliding manner with the cutting guide 200.

Once the guide is positioned, the user places the carriage at a first edge 500a of the panel 500. In FIG. 10, the first edge is situated on the left; this arrangement is suitable for use by a right-handed user. This first edge is the one which is located on the side of the blade of the carriage. Then, the user positions the carriage so that the scoring corner of the blade is in sufficient contact with the panel to score it. The user then displaces the carriage in the direction of the arrow F1, by pulling the carriage, from the first edge 500a of the panel 500 to the second edge 500b of the panel 500. During this movement, according to the arrow F1, the blade makes a score 501 in the layer of plaster of the panel 500. If this layer of plaster is covered with a sheet of paper or of cardboard, the blade cuts this sheet at the same time as it scores the plaster.

During this movement, the user's only concern is to pull the carriage between the two edges of the panel to score and cut this panel. He does not have to be concerned with the inclination of the blade which is held at right angles to the panel by the carriage. By virtue of this, the score is perfectly regular both in its form along the panel and in its depth.

Having arrived at the second edge 500b of the panel, the user folds the panel along the score obtained in the preceding step to break the layer of plaster along the score. This folding in the direction of the arrows F2 (see FIG. 11) makes it possible to obtain a cutting edge 502 illustrated in FIG. 12. By virtue of the perfect straightness of the score, the cutting edge obtained is much more regular than the cutting edges obtained by the method of cutting using the cutter.

To further enhance the flatness of this cutting edge, the carriage according to the invention offers a position of the handle, and therefore of the blade, which makes it possible to trim the cutting edge 502. For this, as illustrated in FIG. 11, the user displaces the carriage from the second edge of the panel to the first edge of the panel, then he positions the blade so that the planar face of the trimming edge is applied against the cutting edge obtained in the step of folding the panel. The user again displaces the carriage from the first edge 500a to the second edge 500b, so that the cutting edge is trimmed by the blade. This step is illustrated in FIGS. 12 and 13. The latter FIG. 13 shows the untrimmed cutting edge 502 on the right of the figure and a trimmed cutting edge 502a on the left of the figure. Obviously, the cutting edge 503 of the scrap piece 504 of the panel 500 is not trimmed during this step.

At the same time as the blade trims the cutting edge, it also cuts, if present, the sheet of paper or of cardboard arranged on the bottom face of the panel of plasterboard.

As during the scoring, the user does not have to be concerned with the inclination of the planar face of the blade during the scoring.

FIG. 15 illustrates an embodiment of a carriage for cutting a panel of plasterboard that is particularly suited to the use of the blade according to the invention.

The carriage 100 comprises a chassis 101 provided with means for cooperating in a sliding manner with a cutting guide 200. The cooperation means are, in this embodiment, small wheels 102 provided with a groove 102a intended to receive a part 201a of a rail 201 borne by the guide 200. Such a guide will be described in more detail in relation to FIGS. 16 to 18.

The small wheels 102 make it possible to slide the chassis 101 along the rail 201.

The chassis 101 comprises a handle 110 mounted to rotate relative to the chassis 101. The handle comprises a gripping means 111 consisting, in this exemplary embodiment, of a profiled hand-hold.

The handle also comprises a recess 112 for a cutting blade 300.

The chassis 101 also comprises a section piece 120 provided with three notches A, B and C. These notches are intended to block the rotation of the handle 110 by virtue of the engaging of a retractable claw 113 borne by the handle. Advantageously, the retractable engaging claw is coupled to a trigger 115 linked to a tension spring 114 pressing the claw toward the bottom of the notches.

In this way, the user who holds the handle 110 by the hand-hold 111 can retract the claw 113 from the notch in which it is engaged (here, the notch B) by pulling, with a finger of the hand placed on the hand-hold 111, the trigger 115, against the tension spring 114. He can then pivot the handle 110 relative to the chassis 101 until the claw 113 is engaged in another notch A or C.

By virtue of the section piece 120 and of the notches A, B and C, the handle can be positioned in a preset manner in three angular positions by reversible engaging of the retractable claw 113 in the notches.

These notches are arranged on the section piece, such that, in use:
the first notch A allows the blade 112 to be positioned out of contact with the panel of plasterboard;
the second notch B allows the blade to be arranged at an angle α with a panel of plasterboard, with sufficient contact with this panel to score it in order to form a cutting edge (see FIGS. 10 and 11);
the third notch C allows the blade 300 to be arranged at an angle β with the panel of plasterboard, with sufficient contact with this panel to trim the cutting edge (see FIGS. 13 and 14) and cut any sheet of paper or of cardboard borne by the bottom face of the panel (the bottom face being the face opposite to the one which bears the guide 200 and/or the carriage 100).

Preferably, the carriage 100 also comprises a protective housing 130 for the blade 300, when the claw 113 is engaged in the first notch A. In this position, the blade is out of contact with the panel of plasterboard. This position advantageously constitutes a secure transport position in which the blade is inaccessible to the user who cannot therefore be injured with the blade.

By virtue of the section piece 120 provided with notches, the angular positions of the handle are predetermined and preset. Thus, the user does not need to pay attention to the angle α or β of the blade relative to the panel of plasterboard. He simply has to switch from one notch to the other to obtain the different positions of the blade. His only concern is to displace the guide relative to the panel.

The angular position of the third notch C depends on the thickness of the panel of plasterboard. In the example illustrated, the third notch C is spaced apart from the second notch B to allow for the trimming of a cutting edge of a panel of plasterboard of a thickness el (see FIG. 14).

Advantageously, the carriage may comprise at least one additional notch (for example, notches D and E) separated from the third notch C to allow for the trimming of a cutting edge of a panel of plasterboard of thickness e2 or e3, different from the thickness e1, that can be trimmed when the trigger is engaged in the notch C. The person skilled in the art will be able to provide as many notches as necessary, depending on the number of thicknesses of panels intended to be cut by the carriage according to the invention. For example, the notch C could make it possible to trim the edge of a panel of plasterboard 10 mm thick, a notch D could make it possible to trim the edge of a panel 13 mm thick (conventionally called, in France, “BA13 panel”), and a notch E could make it possible to trim the cutting edge of a panel 15 mm thick. Other notches could be provided for other thicknesses.

In this case, it is appropriate to provide a length L1 of the trimming edge greater than or equal to the thickness of the panel of plasterboard divided by the sine of the smallest angle β of the notches C, D or E.

With such a carriage, the scoring step illustrated in FIG. 10 is implemented by actuating the retractable engaging claw to withdraw it from the notch A of the transport position and by pivoting the handle until the claw is engaged in the second notch B.

Similarly, the trimming step illustrated in FIG. 13 is implemented by actuating the retractable engaging claw to withdraw it from the second notch B and by pivoting the handle until the claw is engaged in the third notch C.

The preceding cutting carriage advantageously comprises means for cooperating in a sliding manner with a cutting guide.

A particularly suitable cutting guide has a profiled rail such as that which is illustrated in FIG. 16. This guide of the carriage has two longitudinal edges 200a and two ends 200b.

In a particularly advantageous embodiment, the guide 200 has a profiled rail 201, intended to cooperate with the small wheels 102 of the carriage (see FIGS. 15), this rail 201 being extended laterally by flats 202 increasing the contact surface area between the guide and the panel of plasterboard.

The rail 201 can have any kind of form. A particularly advantageous form, illustrated in FIG. 16, allows for a better stability and a better sliding securing of the carriage according to the invention. Around a longitudinal groove 203, the rail 201 comprises two longitudinal protuberances 204. Each of these protuberances has a part 201a intended to cooperate in a sliding manner with the small wheels 102 of the carriage 100. Each part 201a comprises two non-coplanar rectilinear faces 205-206 linked by a flat 207 substantially at right angles to the face of contact 208 of the guide 200 with the panel of plasterboard.

The flats 202 preferably have a width L2 set so that, in use, the cutting blade 300 is in tangential contact with the longitudinal edge 200a of one of the flats 202. By virtue of this, the user can easily position the guide since he simply needs to line up the edge of the flat with the cut marking line previously drawn by the user. Furthermore, the contact between the flat 202 and the blade prevents the latter from oscillating under the action of the movement of the carriage. With a blade that conforms to the invention, it is the planar face of the blade which is applied against the flat 202, and not the beveled face. This further reinforces the guiding of the blade by optimizing the contact surface area between the blade and the guide.

Preferably, the cutting guide according to the invention can have securing means arranged on the face 208 intended to be in contact with the panel of plasterboard. These securing means may comprise spikes intended to be driven into the plaster of the panel of plasterboard.

Thus, when the user has positioned the guide in the desired manner, he simply needs to press on this guide for the spikes of the securing means to be driven into the panel and prevent, during the different cutting steps (see FIGS. 10 to 14) the guide from moving from its position of use.

The spikes may be borne by rods or be retractable to prevent the spikes from injuring the user when the guide is not in use. To this end, the spikes may be borne, for example, by screws inserted into the longitudinal groove 203. When the user wants to use the guide, he extracts the screws from the plane of the surface 208, using a screwdriver. When the user has finished his cuts, he unscrews the screws until they leave the plane of the surface 208. Advantageously, these screws have a length such that, when they are not screwed, they are held in the groove 203 and prevent the cooperation of the carriage with the rail.

Any other means capable of rendering the spikes retractable can be used in the guide according to the invention.

Preferably, the securing means 209 are arranged on the face 208 of the guide so that, in use, after the cutting of the panel of plasterboard, the holes formed by the spikes driven into the panel of plasterboard are situated at a determined distance d from the cut, sufficient for the holes to be filled at the same time as a join between two panels of plasterboard.

For example, the securing means 209 are arranged at the distance d from the edge 200a of the guide.

Conventionally, the finishing operations are performed using a coating knife of a width between 150 mm and 300 mm.

Thus, the spikes of the securing means will preferentially be arranged at a determined distance of between 75 mm and 150 mm, preferably between 70 mm and 120 mm, advantageously between 55 mm and 80 mm, typically 65 mm.

The holes formed by the spikes are arranged in an area particularly close to the cutting edge, so that the finishing does not need to include a specific step of filling these holes, independent of the filling of the space between two consecutive panels.

Advantageously, the cutting guide comprises, at least at one of the ends 200b of the rail 201, an abutment 210 mounted to rotate relative to the rail 201. Advantageously, the abutment is provided with means for securing, in use, against the panel of plasterboard. In the embodiment illustrated in FIG. 17, this securing means comprises a spike 211 intended to be driven into the thickness of the panel of plasterboard. Thus, the user arranges the abutment 210 against an edge of the panel of plasterboard, and secures this abutment against this panel by driving the spike 211 into the thickness of the panel of plasterboard. Then, since the abutment 210 is mounted to rotate relative to the rail 201, he can angularly position the guide on the panel of plasterboard according to his choice as illustrated in FIG. 18.

The securing means may be retractable. For example, a spike 211 is borne by a screw.

Preferably, the rotary mounting of the abutment 210 relative to the rail 201 can be controlled using a thumbwheel 212.

According to an embodiment that is not illustrated, the abutment 210 comprises two parts linked to one another by an articulation.

The two articulated parts can be provided with means for securing the panel of plasterboard. For example, the securing means may be spikes and/or comprise a plate arranged to make it possible to forcibly hold the panel of plasterboard between this plate and the articulated parts. This arrangement can be obtained by producing the articulated parts in a profiled structure.

The abutment may advantageously comprise an end-of-rotation abutment allowing for a limited rotation of the articulated parts. In practice, the end-of-rotation abutment advantageously limits the rotation between 0 and 45°, and preferably between 0 and 30°.

By virtue of these articulated parts, on the means for securing the panel of plasterboard, and on the end-of-rotation abutment, the user can perform a cutting of a panel of plasterboard of large size on his own with no risk that the scrap piece 504 (see FIG. 13) will fall during the trimming step, thus tearing the bottom sheet of paper and/or being broken.

In practice, when the user breaks the panel along the score (see FIG. 11) and begins the trimming of the cutting edge (see FIGS. 13 and 14) the end of the scrap piece already freed is held by the articulated part of the abutment.

According to other embodiments that are not illustrated, the rail of the guide may comprise a retractable stop means to make it possible, in use, to couple and decouple the rail with respect to the carriage. Thus, when the carriage is coupled to the rail, the retractable stop means prevents, in the movement, the carriage from leaving the rail. After use, to facilitate transport, it is desirable to decouple the carriage and the rail. The user then deactivates the retractable stop means and removes the carriage from the rail. For example, a pin provided with a return means can be used as retractable stop means.

It is also possible, alternatively or in combination, to provide at least one of the ends of the rail with a means for damping, in use, the sliding of the carriage at end of travel. Thus, the carriage cannot violently strike the retractable stop means or the carriage cannot violently leave the rail. For example, it is possible to use a spring or a piston as damping means.

1. A blade for cutting a panel of plasterboard, characterized in that it comprises at least one scoring corner having a planar face and a beveled face.

2. The cutting blade as claimed in claim 1, in which the scoring corner is extended by a trimming edge having a planar face and a beveled face that are identical to those of the corner.

3. The cutting blade as claimed in claim 1, also comprising at least one cutting notch arranged between the scoring corner and the trimming edge.

4. The cutting blade as claimed in claim 1, in which the beveled face forms an angle (γ) with the planar face of between 15° and 25°, preferably 20°.

5. The cutting blade as claimed in claim 1, in which the or each scoring corner has a connecting facet.

6. The cutting blade as claimed in claim 2, in which the trimming edge has a length greater than the thickness of the panel of plasterboard.

7. The cutting blade as claimed in claim 3, in which the cutting notch is curved.

8. The cutting blade as claimed in claim 3, consisting of a rectangular plate having two faces and comprising:
four scoring corners;
four cutting notches;
four trimming edges,
two diametrically opposite scoring corners being symmetrical relative to the center of the rectangular plate, two consecutive scoring corners having a planar face and a beveled face that are opposite one another.

9. The cutting blade as claimed in claim 2, consisting of a rectangular plate having two faces and comprising:
our scoring corners;
our cutting notches;
our trimming edges,
two diametrically opposite scoring corners being symmetrical relative to the center of the rectangular plate and two consecutive scoring corners having one and the same planar face and one and the same beveled face.

10. A method for implementing a blade as claimed in claim 1, for cutting a panel of plasterboard, characterized in that it comprises the following steps:
supplying a panel of plasterboard comprising a layer of plaster between two sheet of cardboard or of paper;
applying the scoring corner to the panel so that the planar face of the scoring corner is at right angles to the panel, and displacing the duly positioned blade to cut the first sheet and score the layer of plaster;

11. The method as claimed claim 10, wherein the blade further comprises at least one cutting notch arranged between the scoring corner and the trimming edge,
said method further comprises the following subsequent steps:
folding the panel along the score obtained in the preceding step to break the layer of plaster along the score and obtain a cutting edge;
engaging the cutting notch with the second panel of cardboard and applying the trimming edge against the cutting edge obtained in the preceding step, then displacing the duly positioned blade to trim the cutting edge while cutting the second sheet of cardboard.

12. The use of a blade as claimed in claim 3, comprising at least one scoring corner, at least one cutting notch and at least one trimming edge for cutting a panel of plasterboard.
